(19) United States
(12) Patent Application Publication
(10) Pub. No.: US 2009/0287325 A1
(43) Pub. Date: Nov. 19, 2009

(54) DIGITAL CONTENT PLAYER WITH SOUND-ACTIVATION FUNCTION AND METHOD FOR POWERING ON AND OFF THE DIGITAL CONTENT PLAYER

(76) Inventor: Jun-Cheng CHYOU, Taipei Hsien (TW)

Correspondence Address: HDLS Patent & Trademark Services, P.O. BOX 220746, CHANTILLY, VA, 20153-0746, US

(21) Appl. No.: 12/177,336

(22) Filed: Jul. 22, 2008

(30) Foreign Application Priority Data
May 19, 2008 (TW) 097118399

(51) Int. Cl. G06F 17/00

(52) U.S. Cl. 700/94

(57) ABSTRACT

A digital content player with sound-activation function includes a microphone receiving external sound signal, and an activation controller electrically connected to the microphone. The activation controller is further electrically connected to a power source and a digital content player console. The activation controller supplies electrical power from the power source to the microphone and judges a power on condition and a power off condition based on the external sound signal. The activation controller selectively powers on and off the digital content player console based on the power on and off condition. Therefore, user can remotely activate the digital content player console by, for example, two successive sounds by clapping. A power on operation sequence is automatically performed after the digital content player console is powered on, thus facilitating operation for user.

### BACKGROUND OF THE INVENTION

1. Field of the Invention

The present invention relates to a digital content player and method for powering on and off the digital content player, especially to a digital content player with sound-activation function and method for powering on and off the digital content player.

2. Description of Prior Art

Digital imaging devices, such as digital still camera and camera phone, provide user with the convenience of viewing photo directly without resorting to photograph paper. Therefore, digital photo frames are popular products for viewing digital photo files. For entry-level digital photo frames, memory card support (such as SD, MMC and MS) and JPEG playback are their basic functions. The advanced digital photo frames support the playback of other kinds of digital contents, such as music file playback, video clip playback, and support integrated USB interface, and integration of WiFi/Bluetooth interface as the progress of hardware technology.

The conventional digital photo frames can be remotely controlled by a remote controller. However, the most-frequent function of the digital photo frames is photo file (or multimedia file) playback. The additional physical remote controller increases cost and will cause mess when it is used with the remote controller of other electrical appliances. Therefore, it is desirable to provide a digital content player, such as a digital photo frame, with user-friendly activation function, such as sound-activation function.

### SUMMARY OF THE INVENTION

It is the object of the present invention to provide a digital content player with sound-activation function and method for powering on and off the content player.

Accordingly, the digital content player according to the present invention comprises a microphone receiving external sound signal, and an activation controller electrically connected to the microphone. The activation controller is further electrically connected to a power source and a digital content player console. The activation controller supplies electrical power from the power source to the microphone and judges a power on condition and a power off condition based on the external sound signal. The activation controller selectively powers on and off the digital content player console based on the power on and off condition.

According to one aspect of the present invention, the activation controller is adapted to judge the power on condition when two successive pulses are present in the external sound data and the digital content player is in standby mode. The activation controller is adapted to supply the electric power of the power source to the digital content player console. A temporal separation between peaks of the two successive pulses is at least 0.3 seconds.

According to another aspect of the present invention, the activation controller is adapted to judge the power off condition when two successive pulses are present in the external sound data and the digital content player is in power on mode. The activation controller is adapted to cut off the electric power of the power source to the digital content player console. A temporal separation between peaks of the two successive pulses is at least 0.3 seconds.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a front view of the digital photo frame with sound-activation function according to the present invention.

FIG. 2 shows an internal block diagram of the digital photo frame with sound-activation function according to the present invention.

FIG. 3 is a schematic view showing the waveform of the sound signal detected by the microphone.

FIG. 4 shows the flowchart of a method for operating the digital photo frame with sound-activation function of the present invention.

### DETAILED DESCRIPTION OF THE INVENTION

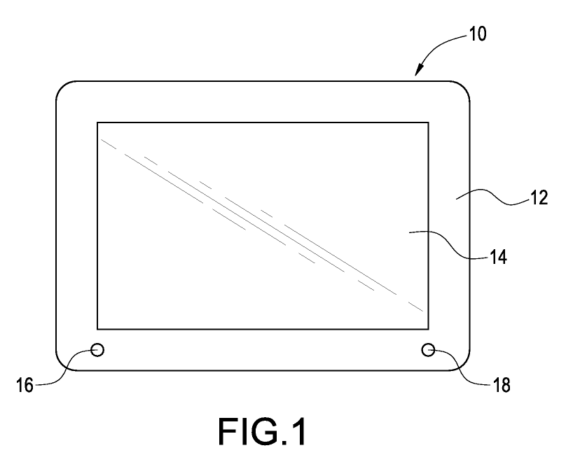

FIG. 1 shows a front view of the digital content player 10 with sound-activation function according to the present invention, where the digital content player is exemplified with a digital photo frame 10. It should be noted that the digital content player can be other electronic devices with digital content playback function, such as DVD player, MP3 player or MP4 player. The digital photo frame 10 comprises a main body 12, a screen 14, a lamp 16 and a sound hole 18, wherein the screen 14, the lamp 16 and the sound hole 18 are preferably located at a front face of the main body 12.

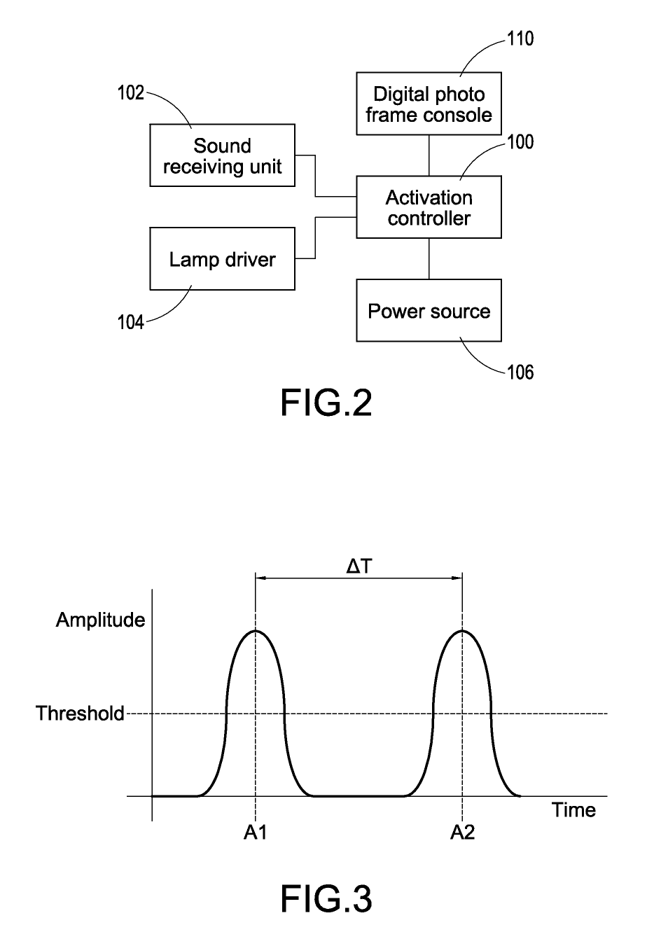

FIG. 2 shows an internal block diagram of the digital photo frame 10 with sound-activation function according to the present invention. As shown in this figure, the digital photo frame 10 further comprises an activation controller 100, a sound receiving unit 102 (hereinafter, the sound receiving unit 102 is exemplified as a microphone 102), a lamp driver 104, a power source 106 and a digital content player console 110 (in this preferred embodiment, digital photo frame console 110). The microphone 102 is arranged with respect to the sound hole 18. The lamp driver 104 is electrically connected to the lamp 16 for driving the lamp 16. The digital photo frame console 110 is the main controlling hardware in conventional digital photo frame and used to playback photo or multimedia files.

When the digital photo frame 10 is in a standby mode, the power source 106 supplies electrical power to the activation controller 100 and the microphone 102. Therefore, the microphone 102 converts external sound signal to a digital audio data, and then sends the digital audio data to the activation controller 100 for further processing. When the digital photo frame 10 is in a standby mode and the digital audio data is judged by the activation controller 100 to match a power on condition, the activation controller 100 supplies the electrical power from the power source 106 to the digital photo frame console 110. Moreover, the activation controller 100 also drives the digital photo frame console 110 to operate a power on operation. In the power on operation, for example, the digital photo frame console 110 playbacks digital content such as photo stored in the digital photo frame 10 in a predetermined sequence. Alternatively, the digital photo frame console 110 playbacks multimedia files (audio or video) stored in the digital photo frame 10 in a predetermined sequence. After the power on operation, the activation controller 100 stops power supplied to the digital photo frame console 110 and returns the digital photo frame 10 back to the standby mode when the digital audio data is judged by the activation controller 100 to match a power off condition.

It should be noted in the above description that the standby mode is referred to a state where the power source 106 still supplies electrical power to the activation controller 100 and the microphone 102. Therefore, the activation controller 100 can judge whether the external sound signal satisfies the power on condition. The power source 106 can be battery power or wall socket power. In power on operation, the power source 106 also supplies electrical power to the digital photo frame console 110, which is an off-the-shelf hardware in conventional digital photo frame, and can be used to playback digital content such as photo, or multimedia files (audio or video) stored in the digital photo frame 10. After the power on operation, the activation controller 100 stops power supplied to the digital photo frame console 110 for saving power when the activation controller 100 judges a power off condition. The term “power off” and “standby mode” are used interchangeably in the present invention. The digital photo frame 10 returns to standby mode when power off condition is met, and electrical power is still supplied to the activation controller 100 and the microphone 102 for monitoring external sound data.

In standby mode, the activation controller 100 controls the lamp driver 104 to trigger the lamp 16 to light in a first color such as red color, thus indicating that the digital photo frame 10 is in the standby mode. After the digital photo frame 10 is in power on operation, the activation controller 100 controls the lamp driver 104 to trigger the lamp 16 to light in a second color such as green color, thus indicating that the digital photo frame 10 is in the power on mode. Alternatively, the activation controller 100 controls the lamp driver 104 to trigger the lamp 16 to light in flashing manner in standby mode, and the activation controller 100 controls the lamp driver 104 to trigger the lamp 16 to light in continuously-lit manner in power on mode (power on operation). Therefore, user can identify the operation mode of the digital photo frame 10.

FIG. 3 is a schematic view showing the waveform of the sound signal detected by the microphone 102, where the sound signal is used as criterion of power on and power off condition. When the activation controller 100 judges there are two successive pulses A1 and A2 with sufficient amplitude and sufficient temporal separation in the sound signal, the criterion of power on or power off condition is met. More particularly, the amplitude of the successive pulses A1 or A2 should be larger than a predetermined amplitude threshold, and the temporal separation ΔT between the peak of the successive pulses A1 and A2 should be larger than a predetermined temporal threshold (for example, 0.3 seconds) to prevent erroneous judgment. The sound signal can be produced by, for example but not limited to, clapping hand, striking hand or knocking on table and so on, and the frequency of the sound signal is within audible range (20-20 KHz). The criterion for the power on condition and the power off condition can be the same or different, depending on designer's choice. Moreover, the power on condition and the power off condition can be stored in a memory (not shown) in the activation controller 100 for the convenience of judgment.

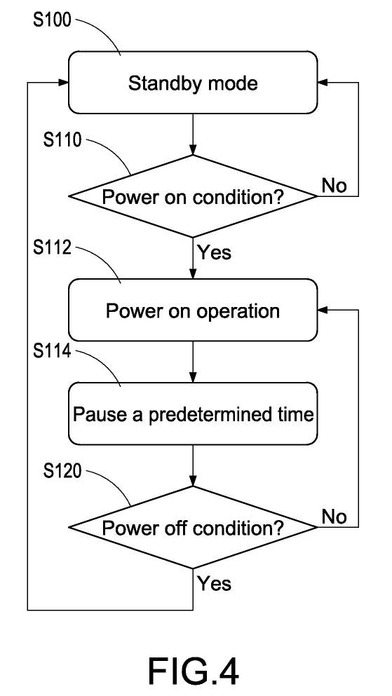

FIG. 4 shows the flowchart of a method for operating the digital photo frame with sound-activation function of the present invention. In standby mode (S100), when the activation controller 100 finds digital audio data (which represents the sound signal) sent from the microphone 102, the activation controller 100 judges whether the digital audio data satisfies a power on condition (S110). When the digital audio data satisfies the power on condition, the power on operation is performed (S112) and a pause period of the activation controller 100 is followed by the power on operation (S114). The pause period of the activation controller 100 is, for example, 8 seconds, to prevent over-frequent power on/off operation of the digital photo frame. After the pause period of the activation controller 100, the activation controller 100 judges whether the digital audio data satisfies a power off condition (S120). If the digital audio data satisfies the power off condition, the digital photo frame is back to the standby mode (S100).

By the digital photo frame with sound-activation function of the present invention, user can power on/off the digital photo frame by making sound such as clapping without the necessity of physically touching buttons on the digital photo frame or using a remote controller. Moreover, the power on operation according to the present invention automatically playbacks digital contents such as photos, music or video clips stored in the digital photo frame by the digital photo frame console 110. Therefore user can enjoy the convenience of automatic power on and showing photos by two successive sounds (for example, clapping).

What is claimed is:

1. A digital content player with sound-activation functions, the digital content player having a digital content player console for playbacking digital content in the digital content player, the digital content player comprising:
a sound receiving unit adapted to receive an external sound data;
an activation controller electrically connected to the sound receiving unit, the digital content player console and a power source, the activation controller adapted to supply an electric power of the power source to the sound receiving unit;
wherein the activation controller is adapted to selectively supply the electric power to the digital content player console by judging a power on condition and a power off condition based on the external sound data.

2. The digital content player in claim 1, wherein the sound receiving unit is a microphone.

3. The digital content player in claim 1, wherein in a standby mode of the digital content player, the activation controller is adapted to judge the power on condition when two successive pulses are present in the external sound data, and the activation controller is adapted to supply the electric power of the power source to the digital content player console.

4. The digital content player in claim 3, wherein a temporal separation between peaks of the two successive pulses is at least 0.3 seconds.

5. The digital content player in claim 1, wherein in a power on mode of the digital content player, the activation controller is adapted to judge the power off condition when two successive pulses are present in the external sound data, and the activation controller is adapted to cut off the electric power of the power source from the digital content player console.

6. The digital content player in claim 5, wherein a temporal separation between peaks of the two successive pulses is at least 0.3 seconds.

7. The digital content player in claim 1, further comprising:
a lamp electrically connected to the activation controller and a color of the lamp is changed by the activation controller.

8. The digital content player in claim 1, wherein the digital content player is a digital photo frame.

9. A method for operating a digital content player, the digital content player having a digital content player console for playbacking digital content in the digital content player, the method comprising:
providing a sound receiving unit in the digital content player;
receiving an external sound data by the sound receiving unit when the digital content player is in a standby mode;
judging a power on condition when two successive pulses are present in the external sound data; and
supplying electric power to the digital content player console when the power on condition is met.

10. The method in claim 9, wherein a temporal separation between peaks of the two successive pulses is at least 0.3 seconds.

11. The method in claim 9, further comprising:
performing a power on operation after the power on condition is met, wherein the digital content player console automatically playbacks the digital content in the digital content player.

12. The method in claim 11, wherein the digital content is one of digital photo, digital music and digital video clip in the digital content player.

13. The method in claim 9, further comprising:
after the power on condition is met, pausing a predetermined pause time to stop checking the external sound data.

14. The method in claim 13, wherein the predetermined pause time is 8 seconds.

15. The method in claim 13, further comprising:
after the predetermined pause time, judging a power off condition when two successive pulses are present in the external sound data; and
cutting off electric power supplied to the digital content player console when the power off condition is met.

16. The method in claim 15, wherein a temporal separation between peaks of the two successive pulses is at least 0.3 seconds.

17. The method in claim 9, wherein the digital content player is a digital photo frame.
